(19) United States
(12) Patent Application Publication
(10) Pub. No.: US 2009/0251805 A1
(43) Pub. Date: Oct. 8, 2009

(54) MULTI-STAGE LENS ACTUATING MODULE

(75) Inventor: Tien-Hsueh WU, TAIPEI (TW)

Correspondence Address: PAI PATENT & TRADEMARK LAW FIRM, 1001 FOURTH AVENUE, SUITE 3200, SEATTLE, WA, 98154, US

(73) Assignee: ALFOCUS TECHNOLOGY CORPORATION, TAIPEI (TW)

(21) Appl. No.: 12/198,883

(22) Filed: Aug. 26, 2008

(30) Foreign Application Priority Data
Apr. 2, 2008 (TW) 97205660

(51) Int. Cl. G02B 7/02

(52) U.S. Cl. 359/823

(57) ABSTRACT

A multi-stage lens actuating module includes a housing with a cavity, a lens holder disposed in the cavity for containing a lens component, an elastic piece disposed between the lens holder and the housing, a flange protruding from a side of the lens holder, and a raised bar protruding from a side of the elastic piece. The flange is contact with the raised bar to determine a stroke of the lens holder.

### RELATED APPLICATIONS

This application claims priority to Taiwan Application Serial Number 97205660, filed Apr. 2, 2008, which is herein incorporated by reference.

### BACKGROUND

1. Field of Invention

The present invention relates to a lens actuating module. More particularly, the present invention relates to a multi-stage lens actuating module.

2. Description of Related Art

Due to advances in photography, most modern cameras can focus on both near and far objects to ensure clear, sharp images. Adjusting the lens makes the light irradiated into the camera aggregated at an optimum position, the so-called focus, and then an image can be clearly recorded by the camera.

Manual focus is used for conventional cameras; in other words, the position of a traditional camera lens is manually adjusted to a point determined by a user's naked eye. Although advanced users may obtain a better effect by manual focus, it may be too difficult for amateur users; therefore, the fully automatic camera has been presented to the public. A fully automatic camera can automatically determine a proper focal distance before an image is recorded; thus, the difficulty in using the camera and the possibility of a faulty focus can be reduced.

Generally, there is a processor and a lens driving mechanism in a camera for simple auto-focus method. According to the tendency for electronic products to be integrated, a camera may also be utilized in a mobile phone or a PDA (personal digital assistant); thus, the price and miniaturization of an electronic device has become an important consideration.

According to the foregoing description, there is a need to reduce the price and the volume of the electronic devices with the photograph camera.

### SUMMARY

The invention provides a multi-stage lens actuating module, which includes a housing with a cavity, a lens holder disposed in the cavity for lo containing a lens component, an elastic piece disposed between the lens holder and the housing, a flange protruding from a side of the lens holder, and a raised bar protruding from a side of the elastic piece. The flange is in contact with the raised bar to determine a stroke of the lens holder.

It is to be understood that both the foregoing general description and the following detailed description are by examples, and are intended to provide further explanations of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an explosive diagram of a first embodiment of the multi-stage actuating module of the invention;

FIG. 2A and FIG. 2B are schematic diagrams of different states of the first embodiment of the multi-stage actuating module of the invention;

FIG. 3 is a schematic diagram of a second embodiment of the multi-stage actuating module of the invention;

FIG. 4 is a schematic diagram of a third embodiment of the multi-stage actuating module of the invention;

FIG. 5 is a schematic diagram of a fourth embodiment of the multi-stage actuating module of the invention; and

FIG. 6A and FIG. 6B are schematic diagrams of different states of a fifth embodiment of the multi-stage actuating module of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

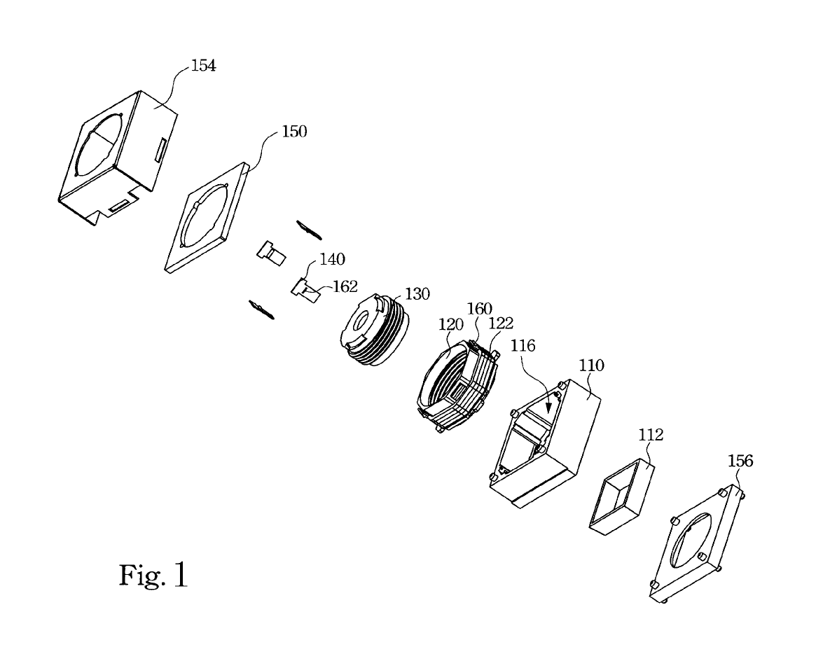

Refer to FIG. 1. FIG. 1 illustrates an explosive diagram of a first embodiment of the multi-stage actuating module of the invention. The multi-stage actuating module 100 includes a housing 110, a lens holder 120, a lens component 130 disposed in the lens holder 120, and an elastic piece 140. The housing 110 has a cavity 116, and the lens holder 120 for containing the lens component 130 may be disposed in the cavity 116. The elastic piece 140 may be disposed between the lens holder 120 and the housing 110. The multi-stage actuating module 100 of the present invention may be utilized in the electronic devices with low-level photographic function, such as a mobile phone, a personal digital assistant (PDA), or a notebook.

The multi-stage actuating module 100 includes an upper cover 150 and a bottom cover 156 disposed on two opposite sides of the housing 110, and a case 154 wrapping the housing 110. The multi-stage actuating module 100 further includes a magnetic device 112 and a conductor coil 122 for actuating the lens holder 120 in the housing 110. The conductor coil 122 may be encircled at an outer surface of the lens holder 120, and the magnetic device 112 may be disposed in the housing 110 and surround the lens holder 120. The magnetic device 112 is fastened on an inner surface of the holder 110, such that the magnetic device 112 can face the conductor coil 122 when the lens holder 120 is placed in the housing 110.

A part of the conductor coil 122 is located in the magnetic line provided by the magnetic device 112, and the magnetic line may perpendicularly cut across the conductor coil 122. When the conductor coil 122 conducts electrical current, the magnetic field of the conductor coil 122 and the magnetic line of the magnetic device 112 may generate a force to push the lens holder 120 in the moving direction.

The multi-stage actuating module 100 may further include a flange 160 protruding from the lens holder 120, and a raised bar 162 protruding from the elastic bar 140. The flange 160 is disposed on a side of the lens holder 120, which faces the elastic piece 140. The raised bar 162 is disposed on a side of the elastic piece 140, which faces the lens holder 120. The flange 160 may be in contact with the raised bar 162.

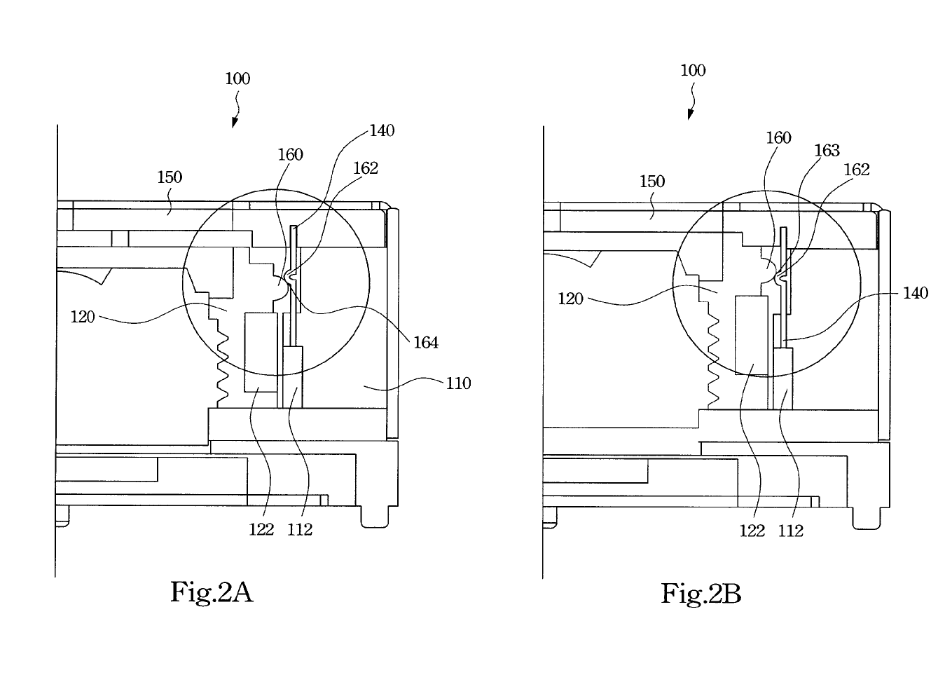

Refer to FIG. 2A and FIG. 2B. FIG. 2A and FIG. 2B illustrate the schematic diagrams of different state of the first embodiments of the multi-stage actuating module of the invention. The elastic piece 140 is disposed between the lens holder 120 and the housing 110. There is only one flange 162 disposed on the lens holder 120. There is only one raised bar 162 disposed on the elastic piece 140. The raised bar 162 includes an upper edge 163 and a lower edge 164. In FIG. 2A, the initial position of the lens holder 120 is at the bottom of the housing 110, the flange 160 touches the lower edge 164 of the raised bar 162. The elastic force provided by the raised bar 162 of the elastic lo piece 140 may repress the flange 160 to keep the lens holder 120 in a first position.

An operation interface of the multi-stage actuating module 100 may be switched to apply a current to the conductor coil 122 of the lens holder 120 when the user wants to change the focus of the lens component 130. The force generated by the charged conductor coil 122 and the magnetic device 112 may force the lens holder 120 to move along the moving direction. Then the flange 160 of the lens holder 120 may cross through the raised bar 162 of the elastic piece 140, as shown in FIG. 2B. The flange 160 is contact with the upper edge 163 of the raised bar 162, and the elastic force provided by the raised bar 162 of the elastic piece 140 may support the flange 162 to keep the lens holder 120 in a second position.

The maximum stroke of the lens holder 120 may be determined by the height of the contact surface between the lens holder 120 and the upper cover 150. The contact surface of the lens holder 120 may touch the contact surface of the upper cover 150 tightly to prevent the lens holder 120 moving continuously when the flange 160 passes through the raised bar 162. But the flange 160 still touches the raised bar 162 of the elastic piece 140 when the lens holder 120 touches the upper cover 150, and the displacement of the lens holder 120 may be regarded as the maximum stroke.

The operation interface of the multi-stage actuating module 100 may be switched by hand to change the current direction of the conductor coil 122 to further change the force direction of the conductor coil 122 and the magnetic device 112, and the lens holder 120 may be disposed between the first position of FIG. 2A and the second position of FIG. 2B. The flange 160 may touch the upper edge 163 or the lower edge 164 of the raised bar 162, and the lens holder 120 may be fixed by the repressing force between the flange 160 and the raised bar 162.

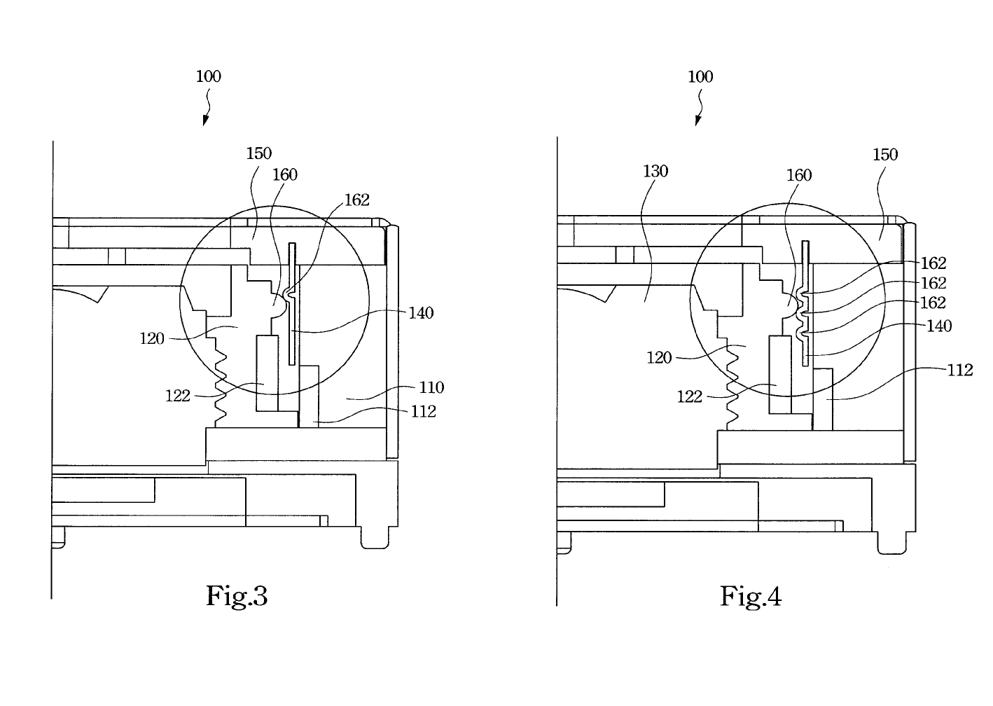

Refer to FIG. 3. FIG. 3 illustrates a schematic diagram of a second embodiment of the multi-stage actuating module of the invention. An end of the elastic piece 140 may be fixed on the upper cover 150. The elastic piece 140 is hung between the lens holder 120 and the housing 110. The static friction between the flange 160 and the raised bar 162 may be reduced by the hung elastic piece 140

The photo mode of the multi-stage actuating module 100 may be switched, and the force generated by the charged conductor coil 122 and the magnetic device 112 may force the flange 160 of the lens holder 120 cross through the raised bar 162 of the elastic piece 140 to change the focus. The current direction of the conductor coil 122 may be changed by manual switching the photo mode of the electronic device, thus the expensive auto-focus processor can be omitted to reduce the price of the multi-stage actuating module 100.

Refer to FIG. 4. FIG. 4 illustrates a schematic diagram of a third embodiment of the multi-stage actuating module of the invention. The elastic piece 140 may be hung on the upper cover 150. There is one flange 160 disposed on the lens holder 120. There is a plurality of the raised bars 162 disposed on the elastic piece 140. The raised bars 162 are arranged in parallel in the moving direction of the lens holder 120. The lens holder 120 of the multi-stage actuating module 100 may move forward or backward in steps lo to the preferred focus. The flange 160 disposed on the lens holder 120 touches one of the raised bars 162, more particularly; the flange 160 touches the upper edge or the lower edge of the raised bar 162. The raised bars 162 may be arranged with a shorter adjacent distance, thus the flange 160 may be clipped between the adjacent raised bars 162.

The contact location of the flange 160 and the raised bars 162 may determine the position of the lens holder 120. The arrangement of the raised bars 162 may further determine the stroke of the lens holder 120, for example, the size, the adjacent distance, the arrange length of the raised bars 162 can be designed according to different requirement to altering the stroke of each stage of the lens holder 120.

The electronic device with the multi-stage actuating module 100 may include the operation interface, such as a control panel, a button, or a knob. The position of the lens component 130 of the multi-stage actuating module 100 may be manual controlled by the operation interface. The lens holder 120 may zoom-in toward the upper cover 150 step by step when the multi-stage actuating module 100 is selected at a macro mode. The current direction of the conductor coil 122 may be changed manually by the operation interface, and the lens holder 120 may zoom-out to the opposite upper cover 150 according to the requirement.

The multi-stage actuating module 100 of the embodiment may further include a low-level processor to automatically choose a preferred position of the lens holder 120 from the plural focus positions. The expensive auto-focus processor may be replaced by the low-level processor to reduce the price of the multi-stage actuating module 100.

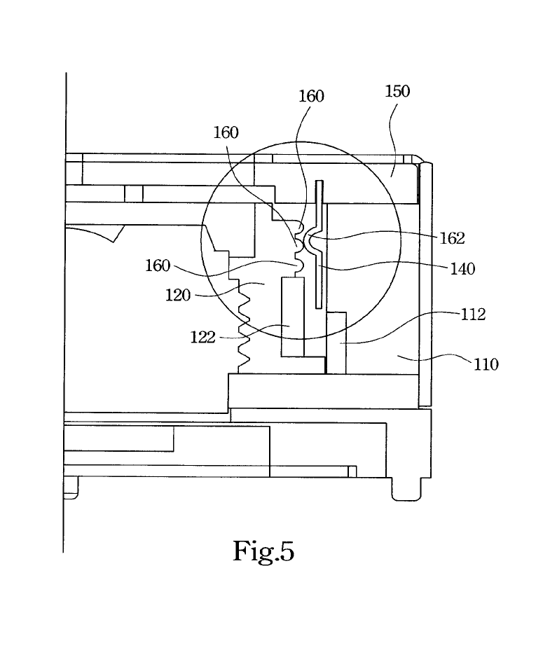

Refer to FIG. 5. FIG. 5 illustrates a schematic diagram of a fourth embodiment of the multi-stage actuating module of the invention. There is one raised bar 162 disposed on the elastic piece 140. There is a plurality of the flanges 160 disposed on the lens holder 120. The flanges 160 are parallel arranged along the moving direction of the lens holder 120. The elastic piece 140 is hung on the upper cover 150 to reduce the static fraction between the flanges 160 and the raised bars 162. The force generated by the charged conductor coil 122 and the magnetic device 112 may force the flanges 160 of the lens holder 120 cross through the raised bar 162 of the elastic piece 140 to change the focus.

The lens holder 120 of the multi-stage actuating module 100 may step by step move forward or backward to the preferred focus. One of the flanges 160 disposed on the lens holder 120 is contact with the raised bar 162. The contact location of the flanges 160 and the raised bar 162 may determine the position of the lens holder 120. The arrangement of the flanges 160 may further determine the stroke of the lens holder 120, for example, the size, the adjacent distance, the number of the flanges 160 can be designed according to different requirement to altering the stroke of each stage of the lens holder 120.

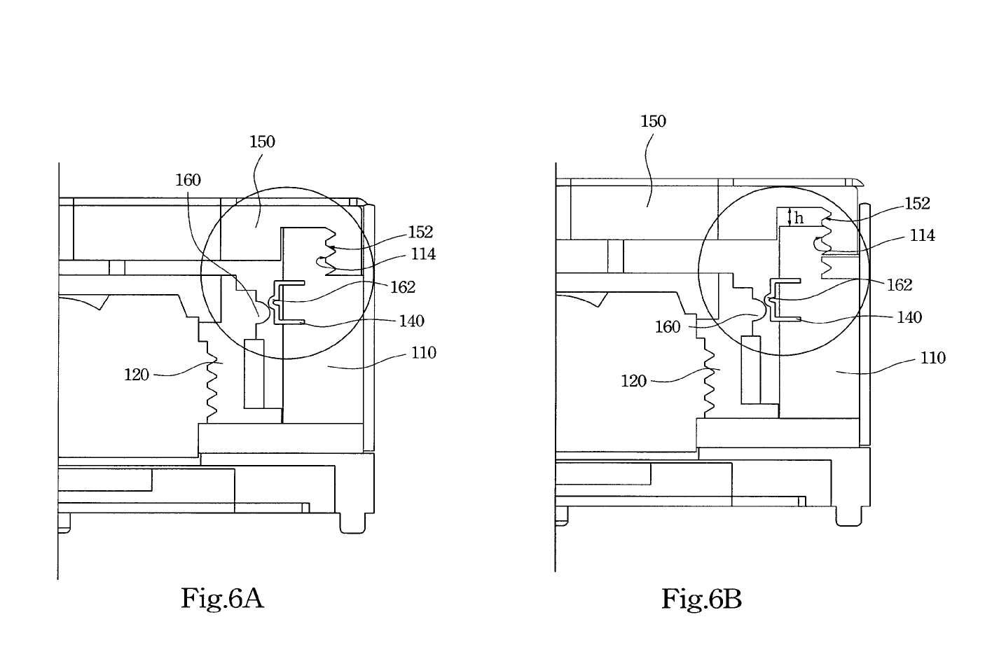

Refer to FIG. 6A and FIG. 6B. FIG. 6A and FIG. 6B illustrate schematic diagrams of a fifth embodiment of the invention. The elastic piece 140 is fixed on the housing 110. The upper cover 150 may have a first thread surface 152 disposed inside. The housing 110 may have a second thread surface 114 disposed outside. The first thread surface 152 may couple with the second thread surface 114 to secure the housing 110 and the upper cover 150. The status of the first thread surface 152 screwed with the second thread surface 114 may be adjusted to define the maximum stroke of the lens holder 120 in different products.

As shown in FIG. 6A, the housing 110 with the second thread surface 114 may screw into the upper cover 150 with the first thread surface 152 completely. The lens holder 120 may be positioned when the flange 160 touches the raised bar 162. The position of the elastic piece 140 is disposed corresponding to the position of the housing 110. The first thread surface 152 may be an inner thread surface, and the second thread surface 114 may be an outer thread surface.

As shown in FIG. 6B, the housing 110 with the second thread surface 114 may not screw into the upper cover 150 with the first thread surface 152 completely. There is a space h formed between the upper cover 150 and the housing 110. The position of the elastic piece 140 is disposed corresponding to the position of the housing 110, which is according to the screw status in this embodiment, and the position of the raised bar 162 in FIG. 6B may be different from the position of the raised bar 162 in FIG. 6A. The position of elastic piece 140 and the raised bar 162 may be altered by the screw status of the first thread surface 152 and the second thread surface 114 to define the maximum stroke of the lens holder 110 precisely.

The material of the elastic piece 140 may be an elastic material, such as a metal, a plastic, or a rubber. The shape of the raised bar 160 may be an arc or a polygon.

The multi-stage lens actuating module of the invention may be utilized in electronic devices. The flange disposed on the lens holder and the raised bar disposed on the elastic piece may be regarded as the position structure to lo position the lens holder in different focus position. The operation interface of the electronic device may be switched annual or automatically to move the lens holder step by step to the preferred focus position. The multi-stage lens actuating module may omit the expensive auto-focus processor to reduce the price of the electronic device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multi-stage lens actuating module comprising:
a housing having a cavity;
a lens holder disposed in the cavity for containing a lens component;
an elastic piece disposed between the lens holder and the housing;
a flange protruding from a side of the lens holder, which faces the elastic piece;
a raised bar protruding from a side of the elastic piece, which faces the lens holder, wherein the flange is contact with the raised bar to determine a stroke of the lens holder.

2. The multi-stage lens actuating module of claim 1, wherein the raised bar comprises an upper edge and a lower edge; the lens holder is arranged at a first position when the flange touches the lower edge of the raised bar, and the lens holder is arranged at a second position when the flange touches the upper edge of the raised bar.

3. The multi-stage lens actuating module of claim 1, further comprising an upper cover disposed at an end of the housing.

4. The multi-stage lens actuating module of claim 3, wherein an end of the elastic piece is fixed on the upper cover, and the elastic piece is hung between the lens holder and the housing.

5. The multi-stage lens actuating module of claim 3, wherein the upper cover comprises a first thread surface; the housing comprises a second thread surface, and the first thread surface couples with the second thread surface.

6. The multi-stage lens actuating module of claim 5, wherein the housing with the second thread surface screws into the upper cover with the first thread surface completely.

7. The multi-stage lens actuating module of claim 5, wherein the housing with the second thread surface does not screw into the upper cover with the first thread surface completely.

8. The multi-stage lens actuating module of claim 5, wherein the elastic piece is fixed on the housing.

9. The multi-stage lens actuating module of claim 5, wherein an end of the elastic piece is fixed on the upper cover, and the elastic piece is hung between the lens holder and the housing.

10. The multi-stage lens actuating module of claim 1, wherein a shape of the raised bar is an arc or a polygon.

11. A multi-stage lens actuating module comprising:
a housing having a cavity;
a lens holder disposed in the cavity for containing a lens component, wherein the lens holder moves in a moving direction;
an elastic piece disposed between the lens holder and the housing;
at least a flange arranged in parallel in the moving direction and protruding from a surface of the lens holder, which faces the elastic piece;
at least a raised bar parallel arranged along the moving direction and protruding from a surface of the elastic piece which faces the lens holder, wherein one of the flanges touches one of the raised bars, and a focus position of the lens component is determined by a contact position of the flanges and the raised bars.

12. The multi-stage lens actuating module of claim 11, wherein each raised bar comprises an upper edge and a lower edge; one of the flanges is in contact with one of the upper edges or one of the lower edges.

13. The multi-stage lens actuating module of claim 11, further comprising an upper cover disposed at an end of the housing.

14. The multi-stage lens actuating module of claim 13, wherein an end of the elastic piece is fixed on the upper cover, and the elastic piece is hung between the lens holder and the housing.

15. The multi-stage lens actuating module of claim 13, wherein the upper cover comprises a first thread surface; the housing comprises a second thread surface, and the first thread surface couples with the second thread surface.

16. The multi-stage lens actuating module of claim 15, wherein the housing with the second thread surface screws into the upper cover with the first thread surface completely.

17. The multi-stage lens actuating module of claim 5, wherein the housing with the second thread surface does not screw into the upper cover with the first thread surface completely.

18. The multi-stage lens actuating module of claim 15, wherein the elastic piece is fixed on the housing.

19. The multi-stage lens actuating module of claim 15, wherein an end of the elastic piece is fixed on the upper cover, and the elastic piece is hung between the lens holder and the housing.

20. The multi-stage lens actuating module of claim 11, wherein a shape of the raised bars is an arc or a polygon.
